(19) United States
(12) Patent Application Publication
(10) Pub. No.: US 2025/0277500 A1
(43) Pub. Date: Sep. 4, 2025

(54) Isolating Fastener Assembly

(71) Applicant: Illinois Tool Works Inc., Glenview, IL (US)

(72) Inventor: James S. Tisol, Chippewa Falls, WI (US)

(21) Appl. No.: 19/012,353

(22) Filed: Jan. 7, 2025

Related U.S. Application Data
(60) Provisional application No. 63/560,131, filed on Mar. 1, 2024.
(60) Provisional application No. 63/572,820, filed on Apr. 1, 2024.

(51) Int. Cl. F16B 5/06

(52) U.S. Cl. CPC F16B 5/0657; F16B 5/065; F16B 5/0664

(57) ABSTRACT

Disclosed is fastener assembly to couple a first component to a second component via a post associated with the second component. The fastener assembly includes a fastener portion and an isolator portion. The fastener portion has a body with a collar at a first end and a base at a second end. The base couples with the first component, and the body defines one of more channels. The isolator portion is formed on the collar and at least a portion of the isolator portion extends into the one of more channels. The fastener assembly defines a passageway therethrough to receive and engage the post via, for example, one or more retainers. The one or more retainers can be resiliently connected to an inner sidewall of the passageway.

### CROSS-REFERENCE

The present application claims priority to U.S. Provisional Patent Application Nos. 63/560,131, filed Mar. 1, 2024, and 63/572,820, filed Apr. 1, 2024, each of which are hereby incorporated by reference in its entirety.

### BACKGROUND

Automotive components require fastening techniques that are simple to manufacture and assemble. Further, fastening techniques should above all be reliable and efficient. In order to secure a first panel to a second panel, a fastener may be used, such as a pin and grommet fastener.

In some examples, the fastener may include an isolator to seal and isolate a primary panel from a secondary panel. The isolator may be fabricated from a pliable material that is different from the fastener material used to fabricate the rigid portions of the fastener (e.g., a fastener stem, head, etc.). It is sometimes advantageous to provide a fastener assembly where the isolator is integral with a fastener (or portion thereof), but still fabricated using a pliable material that enhances the sealing and isolating capabilities of the isolator portion, which would not be of the same material as the other more rigid parts of the fastener assembly.

Despite various advancements to date, it would be desirable to provide a fastener assembly with an integral seal to mitigate buzz, squeak, and rattle (BSR).

### SUMMARY

The present disclosure relates generally to a multi-material fastener assembly that provides, inter alia, an integral isolator portion to serve as an isolator to mitigate BSR, substantially as illustrated by and described in connection with at least one of the figures, as set forth more completely in the claims.

### DRAWINGS

The foregoing and other objects, features, and advantages of the devices, systems, and methods described herein will be apparent from the following description of particular examples thereof, as illustrated in the accompanying figures; where like or similar reference numbers refer to like or similar structures. The figures are not necessarily to scale, emphasis instead being placed upon illustrating the principles of the devices, systems, and methods described herein.

FIG. 1a illustrates an assembly perspective view of an example fastening system configured to form a connection between two components using a fastener assembly in accordance with an aspect of this disclosure.

FIG. 1b illustrates an assembled perspective view of the fastener assembly of FIG. 1a.

FIGS. 2a and 2b illustrate, respectively, underside isometric views of the fastener assembly with an isolator portion separated from a fastener portion and with the isolator portion integrated with the fastener portion.

FIGS. 2c and 2d illustrate, respectively, topside isometric views of the fastener assembly with an isolator portion separated from a fastener portion and with the isolator portion integrated with the fastener portion.

FIGS. 2e and 2f illustrate, respectively, bottom and top plan views of the fastener assembly in accordance with an aspect of this disclosure.

FIGS. 2g and 2h illustrate, respectively, assembled perspective and cross-sectional views of the fastening system taken along cutline A-A (FIG. 2b).

FIGS. 2i and 2j illustrate, respectively, assembled side and cross-sectional views of the fastening system taken along cutline A-A (FIG. 2b).

### DESCRIPTION

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein are not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent or near a second side, the terms “first side” and “second side” do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples, and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y.” As another example, “x, y, and/or z” means any element of the seven-element set {(x), (y), (z), (x, y), (x, z), (y, z), (x, y, z)}. In other words, “x, y, and/or z” means “one or more of x, y, and z.”

Disclosed is a fastener assembly that provides, inter alia, an integral isolator portion to serve as an isolator to mitigate BSR.

In one example, a fastener assembly to couple a first component to a second component via a post associated with the second component comprises: a fastener portion having a body with a collar at a first end and a base at a second end, wherein the base is configured to couple with the first component, and wherein the body defines one of more channels (e.g., flow channels or conduits); and an isolator portion formed on the collar, wherein at least a portion of the isolator portion extends into the one of more channels, and wherein the fastener assembly defines a passageway therethrough configured to receive and engage the post via a one or more retainers. The one or more retainers can be resiliently connected to an inner sidewall of the passageway.

In one example, a multi-material fastener assembly to couple a first component to a second component via a post associated with the second component comprises: a rigid fastener portion having a body with a collar at a first end and a base at a second end, wherein the base is configured to couple with the first component, and wherein the body defines one of more channels; and a pliable isolator portion formed on the collar, wherein at least a portion of the pliable isolator portion extends into the one of more channels, and wherein the multi-material fastener assembly defines a passageway therethrough configured to receive and engage the post.

In another example, the multi-material fastener assembly to couple a first component to a second component via a post associated with the second component comprises: a rigid fastener portion having a body with a collar at a first end and a base at a second end, wherein the base is configured to couple with the first component, and wherein the body defines one of more channels; and a pliable isolator portion comprises an annular disk formed on the collar, and at least one leg that extends into the one of more channels, and wherein the multi-material fastener assembly defines a passageway therethrough configured to receive and engage the post.

In some examples, the isolator portion is fabricated from a first material and the fastener portion is fabricated from a second material that is different from the first material. The fastener portion and the isolator portion can be fabricated to form a fastener assembly via a two-shot injection process or an over-molding process.

In some examples, the base is configured to couple with a doghouse structure of the first component.

In some examples, each of the one of more channels is configured to extend between the base and the collar. The one of more channels can be configured to extend partially or fully between the base and the collar. For example, the one of more channels can be the configured to extend from the collar partially toward the base.

In some examples, each of the one of more channels comprises a linear channel and a flared end.

In some examples, the isolator portion comprises an annular disk and a plurality of legs. The annular disk can be formed on the collar and each of the plurality of legs extends into one of the one of more channels.

In some examples, the fastener assembly comprises one or more fingers positioned in the passageway and configured to engage a head portion of the post. The one or more fingers can be rigidly connected to an inner sidewall of the passageway.

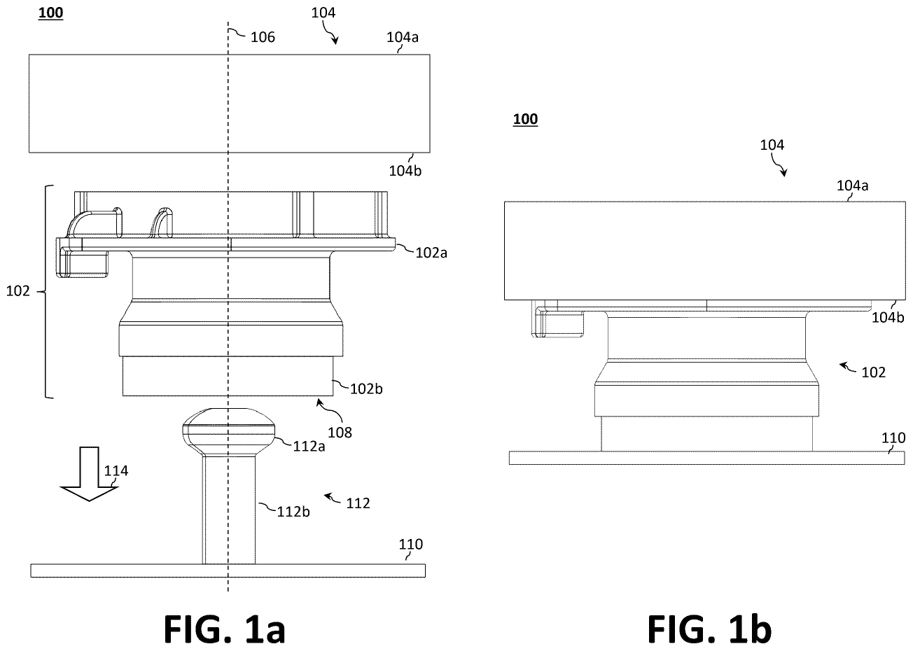

FIGS. 1a and 1b illustrate, respectively, assembly and assembled perspective views of an example fastening system 100 configured to form a connection between two components (illustrated as a first component 104 and a second component 110) in accordance with an aspect of this disclosure. As illustrated, the fastening system 100 includes a fastener assembly 102 that generally comprises a fastener portion 102a and an isolator portion 102b. The fastener assembly 102 is configured as a push-on fastener assembly to join a first component 104 to a second component 110 via a post 112 (or stud, bolt, threaded shaft, etc.) associated with the second component 110. The described fastener assembly 102 is configured as a multi-material fastener assembly.

The illustrated fastener assembly 102 is configured to form a blind connection between the first component 104 and the second component 110. While only a single fastener assembly 102 is illustrated in the examples, it should be appreciated that multiple push-on fastener assemblies 102 and posts 112 may be used to couple a first component 104 to a second component 110, depending on the number of fastener points needed between the first and second components 104, 110. For example, larger components and panels typically require multiple fastening points.

The first component 104 and the second component 110 may be, for example, automotive panels. Depending on the application, the first component 104 and the second component 110 may be fabricated from, for example, metal (or a metal alloy), synthetic or semi-synthetic polymers (e.g., plastics, such as acrylonitrile butadiene styrene (ABS) and polyvinyl chloride (PVC), etc.), composite materials (e.g., fiber glass), or a combination thereof. In the automotive industry, example first components 104 include, without limitation, door trim panels, moldings, trim pieces, and other substrates (whether used as interior or exterior surfaces). The second component 110 may be, for example, a structural component of a vehicle, such as doors, pillars (e.g., an A-pillar, B-pillar, C-pillar, etc.), dashboard components (e.g., a cross member, bracket, frame, etc.), seat frames, center consoles, fenders, sheet metal framework, or the like.

The first component 104 includes one or more attachment devices and/or related features configured to couple with and secure the fastener assembly 102 (e.g., via a base of the fastener portion 102a). The first component 104 may define an A-surface 104a and a B-surface 104b (illustrated as an undersurface). The A-surface 104a, also called a class A surface, is typically the surface that is visible after assembly and, for that reason, is more aesthetically pleasing (e.g., textured, coated, or otherwise decorated) and typically free of attachment devices and/or related features. Conversely, the B-surface 104b, also called a class B surface, is typically the surface that is not visible after assembly and typically includes various attachment devices and/or related features, such as a doghouse interface, receptacle, etc. The various attachment devices can be formed in the first component 104 during manufacturing thereof or added post-manufacture through a mechanical process.

The second component 110 includes one or more posts 112 configured to engage the one or more fastener assemblies 102. As illustrated, each of the one or more posts 112 is generally perpendicular to the second component 110. The illustrated post 112 includes a head portion 112a (e.g., a bulbous head) positioned at a distal end of a shank portion 112b. As illustrated, the head portion 112a and the shank portion 112b are concentric relative to and about a longitudinal axis 106 of the fastener assembly 102 (e.g., when assembled).

In some examples, the post 112 can be threaded along, for example, the shank portion 112b to increase friction with features of the fastener portion 102a. Depending on the material type, the one or more posts 112 may be formed during casting, molding, or layup of the second component 110, or attached after fabrication (e.g., using adhesive or mechanical fasteners). In some examples, the second component 110 and its one or more posts 112 are cast structures. A cast structure, in an automotive context, refers to a frame, chassis, or other component that is produced using a casting process. The choice of metal for casting can vary but often includes materials like iron or aluminum.

During assembly, the fastener assembly 102 is attached to the first component 104 via one or more attachment features and/or related features. The more attachment features and/or related features could include, inter alia, a doghouse interface, a receptacle, snaps, clips, threaded coupling, or otherwise. For example, one or more push-on fastener assemblies 102 can be attached to a doghouse structure (or otherwise) by an end user (e.g., a Tier supplier) so that the first component 104 can be packaged and shipped to an original equipment manufacturer (OEM) as a part-in-assembly (PIA) for final assembly. In one example, the doghouse interface includes a receptacle sized and shaped to receive and secure a portion of the fastener assembly 102 (e.g., the fastener portion 102a).

The combination of the first component 104 and the fastener assembly 102 (e.g., as a PIA) can be pushed onto the post 112 of the second component 110 in the direction indicated by arrow 114 such that the post 112 passes into and at least partly through a passageway 108 formed through the fastener assembly 102 (or vice versa, for example, where the first component 104 is stationary and the second component is moved relative to the first component 104). The fastener assembly 102 can then be similarly pushed onto the post 112 in the direction indicated by arrow 114, thus securing the first component 104 relative to the second component 110. After assembly, as best illustrated in FIG. 1b, the second component 110 is covered at least partially by the first component 104.

To disassemble the fastener assembly 102, the first component 104 is pulled directly from the second component 110 until fastener separation occurs between the post 112 and the fastener portion 102a. For reinstallation of the first component 104, the fastener portion 102a is aligned with the post 112 and pushed back to its previous retention position for reassembly.

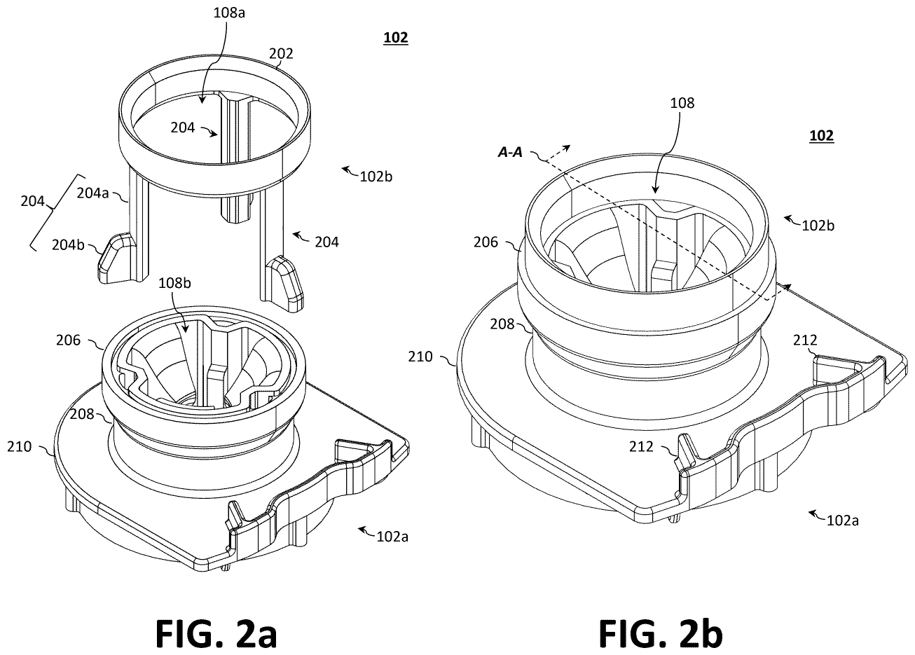

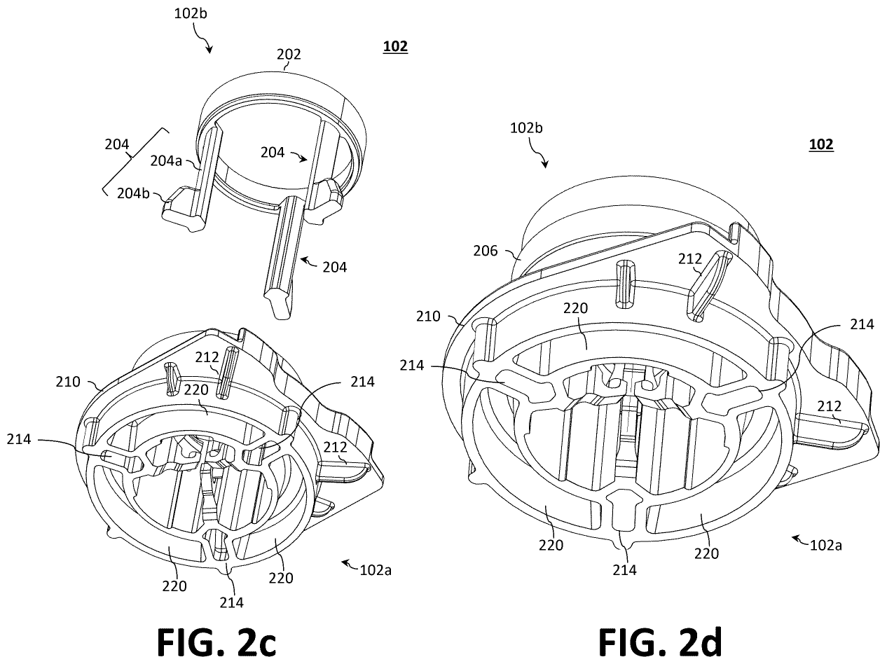

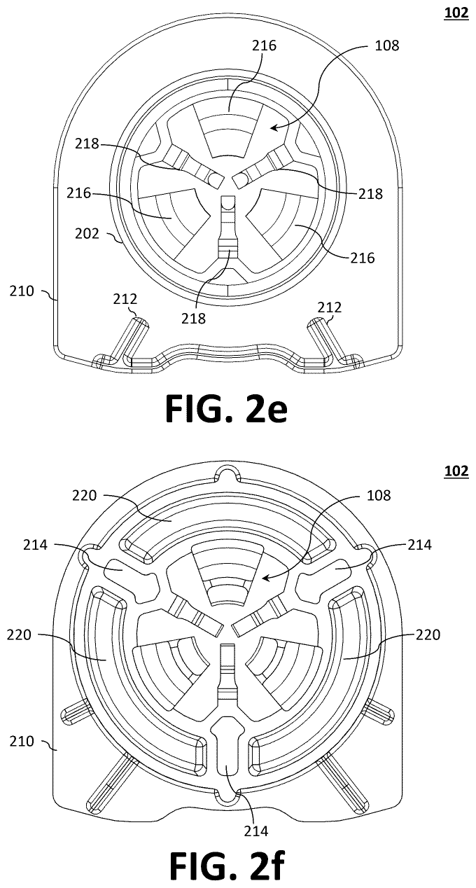

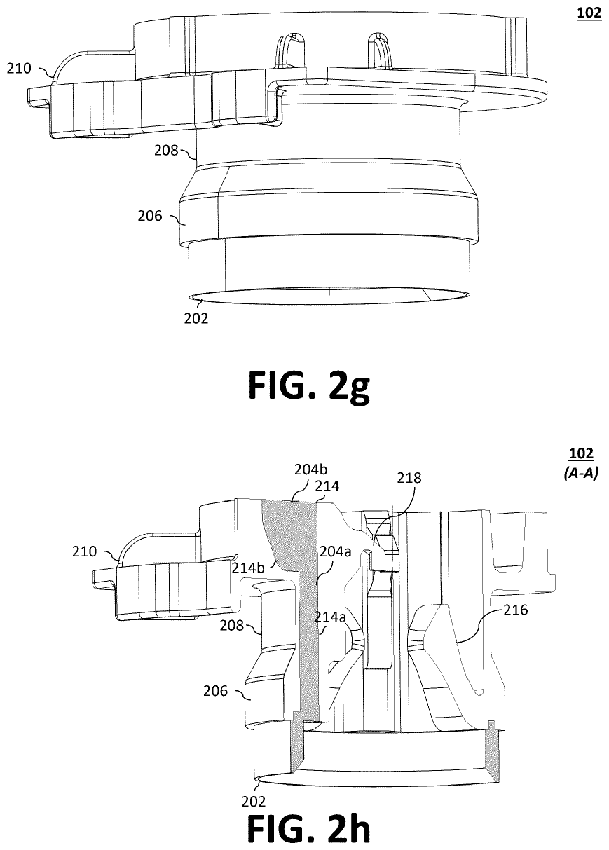

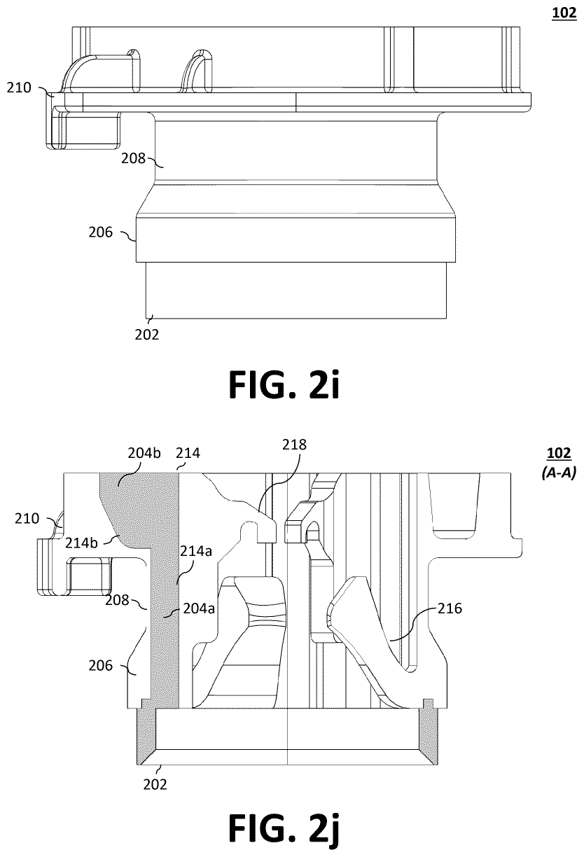

FIGS. 2a and 2b illustrate, respectively, underside isometric views of the fastener assembly 102 with isolator portion 102b separated and with the isolator portion 102b with isolator portion 102b included. FIGS. 2c and 2d illustrate, respectively, topside isometric views of the fastener assembly 102 with the isolator portion 102b separated from the fastener portion 102a and with the isolator portion 102b with isolator portion 102b included with the fastener portion 102a. FIGS. 2e and 2f illustrate, respectively, bottom and top plan views of the fastener assembly 102 in accordance with an aspect of this disclosure. FIGS. 2g and 2h illustrate, respectively, assembled perspective and cross-sectional views of the fastening system 100 taken along cutline A-A (FIG. 2b), while FIGS. 2i and 2j illustrate, respectively, assembled side and cross-sectional views of the fastening system 100 taken along cutline A-A (FIG. 2b).

The illustrated fastener assembly 102 generally comprises the fastener portion 102a and the isolator portion 102b. As illustrated, the fastener assembly 102 is configured as a multi-material fastener assembly 102 having the fastener portion 102a and the isolator portion 102b. The fastener portion 102a can be coupled to or integrated with the isolator portion 102b to provide a sealed connection. In practice, the isolator portion 102b is integral with the fastener portion 102a (i.e., permanently attached) and is positioned on or adjacent the collar 206; however, for ease of illustration, the isolator portion 102b is illustrated separately in FIGS. 2a and 2c to better illustrated its features and shape. In use, the isolator portion 102b provides a seal against a surface to which the panel clip abuts (e.g., the second component 110) to mitigate BSR, thus serving as an anti-rattle isolator.

The fastener portion 102a generally comprises a body 208 (e.g., an annular body) that defines the first opening 108a therethrough with a collar 206 at one end and a base 210 at the other end. The illustrated body 208, the collar 206, and the base 210 are formed as an integral component from a single material. In some examples, the fastener portion 102a comprises one or more windows 220 (e.g., recesses, cut outs, or openings) formed in or on the fastener portion 102a. The one or more windows 220 can serve to reduce the amount of material needed to fabricate the fastener portion 102a, thus reducing material cost and part weight.

The base 210 is configured to attach to the first component 104. In some examples, the base 210 defines and/or is shaped to define one or more anti-rotation features 212. The one or more anti-rotation features 212 can be provided in the form of fins or other features. In the illustrated example, the base 210 is further shaped as a clipped circle (e.g., D-shaped), however other shapes are contemplated; including circular. The anti-rotation features 212 serve to, for example, mitigate rotation of the fastener portion 102a relative to the first component 104 about the axis 106.

The collar 206 is positioned at the entrance to the first opening 108a formed via the body 208. The collar 206 is configured to receive the post 112 and to generally abut the second component 110 via the isolator portion 102b. In the illustrated example, the collar 206 is generally annular.

The body 208 is illustrated as generally cylindrical and configured to receive the post 112. The body 208 is configured to engage the post 112 via one or more retainers 216 and one or more fingers 218, each of which is configured to extend into the first opening 108a and toward the axis 106. The one or more retainers 216 and one or more fingers 218 can be resiliently connected to an inner sidewall of the first opening 108a and configured to deflect as the post 112 is passed through the first opening 108a.

In one example, the one or more retainers 216 are resiliently connected to an inner sidewall of the first opening 108a and configured to deflect as the post 112 is passed through the first opening 108a and the one or more fingers 218 are rigidly connected to the inner sidewall of the first opening 108a and configured to abut the post 112. When assembled, the one or more retainers 216 and one or more fingers 218 are configured to engage the post 112 within the first opening 108a. The retainers 216 secure the post 112 (e.g., via the head portion 112a and/or shank portion 112b) via an interference fit, while the fingers 218 engage the head portion 112a to mitigate wobble and to serve as a stop during assembly with the post 112.

In the illustrated example, three retainers 216 are positioned in the second opening 108b and distributed 120 degrees about the axis 106 of the passageway 108. Similarly, three fingers 218 are positioned in the second opening 108b and distributed 120 degrees about the second opening 108b. While three retainers 216 and three fingers 218 are illustrated, the number of retainers 216 and fingers 218 positioned about the axis 106 in the passageway 108 of the fastener assembly 102 can be increased or decreased based on the retention and insertion forces needed (or desired) relative to the post 112.

The isolator portion 102b can be over formed on the collar 206. In one example, the isolator portion 102b can be formed by injecting the second material through the fastener portion 102a from an end adjacent the base 210 via one of more flow channels 214 (e.g., channels, conduits, etc.) and out an end adjacent the collar 206. As illustrated, one of more flow channels 214 can be formed in the body 208 of the fastener portion 102a and configured to extend between the base 210 and collar 206. For example, each of the one of more flow channels 214 can define a channel opening at each of the base 210 and collar 206. While each of the one of more flow channels 214 is illustrated as extending between the base 210 and collar 206, it is contemplated that the one of more flow channels 214 can be configured to extend only partially between the base 210 and collar 206. For example, the one or more flow channels 214 can be configured to extend from the collar 206 only partially toward the base 210. That is, the one of more flow channels 214 can define a channel opening at the collar 206, but is closed at its other end at a point between the base 210 and collar 206 (e.g., one quarter, one half, three quarters, etc. the way toward the base 210).

The isolator portion 102b can, therefore, be embodied as an annular disk 202 having a plurality of legs 204. In the illustrated example, each of the one of more flow channels 214 comprises a generally linear channel 214a with a flared end 214b. The flared end 214b is enlarged compared to the linear channel 214a and configured to, for example, form a foot shape or a bulbous shape (or otherwise) to prevent pull out of the isolator portion 102b from the end at the collar 206.

The linear channel 214a is configured to convey the second material as needed between a mold cavity for an annular disk 202 at the collar 206 and the flared end 214b. In some examples, as best illustrated in FIG. 2f, each flow channel 214 can be chamfered at the flared end 214b (e.g., with a cross-section resembling an arrow shape). Where desired, the flared end 214b can serve as an entrance to the flow channel 214 such that a second material can be injected from the base end. In this example, the flared end 214b can be configured to receive of otherwise engage a nozzle and to receive the second material.

The isolator portion 102b is attached to the fastener portion 102a at the collar 206 and via one of more flow channels 214. The connection between the fastener portion 102a and the isolator portion 102b must be adequate to prevent the isolator portion 102b from detaching from the fastener portion 102a prior to, during, and/or post installation, assembly, and/or disassembly by the end user. The isolator portion 102b can therefore be formed such that the annular disk 202 is positioned on the collar 206 via mold tooling and a plastic-injection molding process. As illustrated, the collar 206 defines a first opening 108a that aligns with the second opening 108b to define the passageway 108.

To provide an adequate connection between the fastener portion 102a and isolator portion 102b, one or both of the fastener portion 102a and isolator portion 102b may include one or more interlocking features to increase the bond; thus, providing a higher degree of mechanical retention. For example, at least a portion of the isolator portion 102b can extend into the one of more flow channels 214. In this example, the plurality of legs 204 are formed and/or defined by the one of more flow channels 214. For example, the material of the isolator portion 102b will conform to the shape of the one of more flow channels 214, the collar 206, and the mold to ultimately form an integrated fastener assembly 102.

In the illustrated example, each leg 204 comprises a linear portion 204a that corresponds to the shape of the linear channel 214a and a foot portion 204b that corresponds to the shape of the flared end 214b. Each flow channel 214 and its associated legs 204 interact with one other to further increase the adhesion between the fastener portion 102a and the isolator portion 102b by increasing the surface area contact between the fastener portion 102a and the isolator portion 102b.

The fastener assembly 102 can be made from various materials, including synthetic or semi-synthetic polymers (e.g., plastics, such as acrylonitrile butadiene styrene (ABS) and polyvinyl chloride (PVC), etc.), composite materials (e.g., fiber glass), metal (or a metal alloy), or a combination thereof. Some materials are more conducive for sealing than mechanical attachment. In some examples, the first material is a part material that is generally rigid, such as synthetic or semi-synthetic polymers, composite materials, or a combination thereof. Therefore, the fastener portion 102 is fabricated from a first material (e.g., a rigid material) and the isolator portion 102b is fabricated from a second material (e.g., a pliable material) that is different from the first material.

Example rigid materials include, inter alia, nylon (PA), polyetherimide (PEI), polyoxymethylene (POM), polypropylene (PP), high-density polyethylene (HDPE), acrylonitrile butadiene styrene (ABS), polystyrene (PS), and the like. The second material may be a pliable (e.g., flexible and/or conformable seal material, such as a foam material, an elastomeric material (e.g., a thermoplastic elastomer (TPE)), a rubber material (e.g., open cell rubber, closed cell rubber, natural rubber, synthetic rubber, etc.), and the like.

To form the integrated fastener assembly 102, one of the fastener portion 102a or the isolator portion 102b can be first molded to provide a desired profile, after which the other of the fastener portion 102a or the isolator portion 102b may be molded. The order in which the fastener portion 102a and the isolator portion 102b are molded will depend on the manufacturing technique employed. For example, in a two-shot (2K) plastic injection process, the fastener portion 102a can be molded first due in part to the flow channel(s) 214, and the isolator portion 102b can be molded second. An example two-shot injection process is described in commonly owned U.S. Pat. No. 6,752,950 to Martin D. H. Clarke, which is entitled “Two Shot Molding Method And Fastener Clip With Seal Made Thereby.” In other examples, the isolator portion 102b is over-molded onto the collar 206 of the fastener portion 102a.

The fastener assembly 102 can be fabricated using a two-shot plastic injection molding process that forms a component via a first shot injection and a second shot injection. Two-shot plastic injection molding processes are useful can be used to create complex parts using multiple colors and/or multiple materials in a single molding operation. By way of illustration, two separate molds can be prepared; one for each portion of the fastener assembly 102—such as the fastener portion 102a and the isolator portion 102b. To that end, two-shot injection molding machines can be equipped with multiple barrels and nozzles to accommodate different materials. The molds are mounted onto the machine's platens, and the injection molding machine is configured and calibrated for the specific parameters required for the part.

During the first shot injection, the first material, serving as the substrate or base material, is injected into the mold cavity using one of the machine's nozzles to form the fastener portion 102a. The mold is then partially cooled to allow the first material to solidify. In some examples, the fastener portion 102a can be maintained in a slightly molten state to facilitate bonding with the second shot. Once the fastener portion 102a is partially cooled, the mold can be opened slightly, and the second material is injected into the mold cavity to form the isolator portion 102b. In some examples, the second material is injected into the mold cavity via a different nozzle and configured to pass at least partially into or through one of more flow channels 214 formed in the fastener portion 102a. After the second shot of material is injected, the mold is fully cooled to solidify both materials to form the fastener assembly 102. Once cooled, the mold is opened, and the fastener assembly 102 is ejected from the mold cavity where any excess flash material can be trimmed off.

In another example, one or more components of the fastener assembly 102 can be a printed thermoplastic material component, which can be printed with great accuracy and with numerous details. In addition, additive manufacturing techniques obviate the need for mold tooling typically associated with plastic injection molding, thereby lowering up-front manufacturing costs, which is particularly advantageous in low-volume productions. In some examples, components of the fastener assembly 102 may be fabricated using material extrusion (e.g., fused deposition modeling (FDM), stereolithography (SLA), selective laser sintering (SLS), material jetting, binder jetting, powder bed fusion, directed energy deposition, VAT photopolymerisation, and/or any other suitable type of additive manufacturing/3D printing process. For example, the fastener portion 102a can be a printed thermoplastic material component that is then over-molded with the isolator portion 102b.

The above-cited patents and patent publications are hereby incorporated by reference in their entirety. While the present method and/or system has been described with reference to certain implementations, it will be understood by those skilled in the art that various changes may be made and equivalents may be substituted without departing from the scope of the present method and/or system. In addition, many modifications may be made to adapt a particular situation or material to the teachings of the present disclosure without departing from its scope. For example, block and/or components of disclosed examples may be combined, divided, re-arranged, and/or otherwise modified. Therefore, the present method and/or system are not limited to the particular implementations disclosed. Instead, the present method and/or system will include all implementations falling within the scope of the appended claims, both literally and under the doctrine of equivalents.

What is claimed:

1. A fastener assembly to couple a first component to a second component via a post associated with the second component, the fastener assembly comprising:
a fastener portion having a body with a collar at a first end and a base at a second end,
wherein the base is configured to couple with the first component, and
wherein the body defines one of more channels; and
an isolator portion formed on the collar,
wherein at least a portion of the isolator portion extends into the one of more channels, and
wherein the fastener assembly defines a passageway therethrough configured to receive and engage the post via one or more retainers.

2. The fastener assembly of claim 1, wherein the isolator portion is fabricated from a first material and the fastener portion is fabricated from a second material that is different from the first material.

3. The fastener assembly of claim 2, wherein the fastener portion and the isolator portion are fabricated to form a fastener assembly via a two-shot injection process or an over-molding process.

4. The fastener assembly of claim 1, wherein the base is configured to couple with a doghouse structure of the first component.

5. The fastener assembly of claim 1, wherein each of the one of more channels is configured to extend between the base and the collar.

6. The fastener assembly of claim 1, wherein each of the one of more channels is configured to extend partially between the base and the collar.

7. The fastener assembly of claim 6, wherein each of the one of more channels is configured to extend from the collar partially toward the base.

8. The fastener assembly of claim 1, wherein each of the one of more channels comprises a linear channel and a flared end.

9. The fastener assembly of claim 1, wherein the isolator portion comprises an annular disk and a plurality of legs.

10. The fastener assembly of claim 9, wherein the annular disk is formed on the collar and each of the plurality of legs extends into one of the one of more channels.

11. The fastener assembly of claim 1, wherein the one or more retainers are resiliently connected to an inner sidewall of the passageway.

12. The fastener assembly of claim 1, wherein the fastener assembly comprises one or more fingers positioned in the passageway and configured to engage a head portion of the post.

13. The fastener assembly of claim 12, wherein the one or more fingers are rigidly connected to an inner sidewall of the passageway.

14. A multi-material fastener assembly to couple a first component to a second component via a post associated with the second component, the multi-material fastener assembly comprising:
a rigid fastener portion having a body with a collar at a first end and a base at a second end,
wherein the base is configured to couple with the first component, and
wherein the body defines one of more channels; and
a pliable isolator portion formed on the collar,
wherein at least a portion of the pliable isolator portion extends into the one of more channels, and
wherein the multi-material fastener assembly defines a passageway therethrough configured to receive and engage the post.

15. The multi-material fastener assembly of claim 14, wherein each of the one of more channels is configured to extend between the base and the collar.

16. The multi-material fastener assembly of claim 14, wherein each of the one of more channels comprises a linear channel and a flared end.

17. The multi-material fastener assembly of claim 14, wherein the pliable isolator portion comprises an annular disk and a plurality of legs.

18. A multi-material fastener assembly to couple a first component to a second component via a post associated with the second component, the multi-material fastener assembly comprising:
a rigid fastener portion having a body with a collar at a first end and a base at a second end,
wherein the base is configured to couple with the first component, and
wherein the body defines one of more channels; and
a pliable isolator portion comprising an annular disk formed on the collar, and at least one leg that extends into the one of more channels, and
wherein the multi-material fastener assembly defines a passageway therethrough configured to receive and engage the post.

19. The multi-material fastener assembly of claim 18, wherein each of the one of more channels is configured to extend between the base and the collar.

20. The multi-material fastener assembly of claim 18, wherein each of the one of more channels comprises a linear channel and a flared end.
